(19) United States
(12) Patent Application Publication
(10) Pub. No.: US 2003/0079142 A1
(43) Pub. Date: Apr. 24, 2003

(54) Classifying digital object security category

(75) Inventors: Dany Margalit, Ramat Gan (IL); Ofer Elzam, Kiriat Haim (IL); Shimon Gruper, Haifa (IL)

Correspondence Address: Ladas & Parry, 26 West 61st Street, New York, NY, 10023, US

(73) Assignee: ALADDIN KNOWLEDGE SYSTEMS LTD.

(21) Appl. No.: 10/037,109

(22) Filed: Oct. 22, 2001

(51) Int. Cl. H04L 9/00

(52) U.S. Cl. 713/200

(57) ABSTRACT

A method and system for detecting malicious content including the steps of examining at least two characteristics of a digital object, analyzing the at least two characteristics to determine whether there exists a mismatch therebetween and upon determination of the existence of a mismatch, classifying the digital object as a digital object possibly containing malicious content.

### FIELD OF THE INVENTION

The present invention relates to computer systems and methodologies generally and more particularly to systems and methodologies for detecting the presence of malicious content.

### BACKGROUND OF THE INVENTION

There exist various techniques for detecting the presence of malicious content. The following U.S. patents are believed to represent the current state of the art: U.S. Pat. Nos. 5,473,769; 5,696,822; 5,991,774.

### SUMMARY OF THE INVENTION

The present invention seeks to provide an improved system and methodology for detecting the presence of malicious content.

There is thus provided in accordance with a preferred embodiment of the present invention a method of detecting malicious content. The method includes examining at least two characteristics of a digital object, analyzing the characteristics to determine whether there exists a mismatch therebetween and upon determining the existence of a mismatch, classifying the digital object as a digital object possibly containing malicious content.

There is also provided in accordance with a preferred embodiment of the present invention a method of detecting malicious content. The method includes obtaining information relating to at least two characteristics of a digital object, analyzing the information to categorize the digital object into at least two categories, comparing the categories to decide whether there exists a mismatch therebetween and upon determining the existence of a mismatch, classsifying the digital object as a digital object possibly containing malicious content.

There is provided in accordance with yet another preferred embodiment of the present invention a method of detecting malicious content. The method includes examining at least two characteristics of a digital object, each of which characteristics may be selected by a creator of the digital object independently of selection of another characteristic, analyzing the characteristics to determine whether there exists a mismatch therebetween and upon determining the existence of a mismatch, classifying the digital object as a digital object possibly containing malicious content.

There is further provided in accordance with a preferred embodiment of the present invention a system for detecting malicious content. The system includes a digital object examiner, which examines at least two characteristics of a digital object, a characteristics mismatch detector, which analyzes the characteristics to determine whether there exists a mismatch therebetween and a digital object classifier, operating upon the determination of the existence of a mismatch, for classifying the digital object as a digital object possibly containing malicious content.

There is also provided in accordance with another preferred embodiment of the present invention a system for detecting malicious content. The system includes a digital object information obtainer, obtaining information related to at least two characteristics of a digital object, a characteristic based categorizer, categorizing the information into at least two categories, a categories mismatch detector, analyzing the categories to determine whether there exists a mismatch therebetween and a digital object classifier, operating upon determining the existence of a mismatch, classifying the digital object as a digital object possibly containing malicious content.

There is further provided in accordance with yet another preferred embodiment of the present invention a system for detecting malicious content. The system includes a digital object examiner, for examining at least two characteristics of a digital object, each of the characteristics may be selected by a creator of the digital object independently of selection of another characteristic, a characteristics mismatch detector, analyzing the characteristics to determine whether there exists a mismatch therebetween and a digital object classifier, operating upon determining the existence of a mismatch, classifying the digital object as a digital object possibly containing malicious content.

Further in accordance with a preferred embodiment of the present invention the malicious content includes malicious code. Additionally or alternatively, the malicious content includes the masqueraded content.

Still further in accordance with a preferred embodiment of the present invention at least one of the characteristics is selected from a set consisting of: header information, file content, file name extension and file icon.

Preferably, the digital object is selected from a set consisting of: a file, an e-mail attachment, a web page and a storage medium.

Additionally in accordance with a preferred embodiment of the present invention the digital object includes a file, an e-mail attachment, a web page and/or a storage medium.

Still further in accordance with a preferred embodiment of the present invention the characteristics include header information and file content, header information and file name extension, header information and file icon, file content and file icon, file name extension and file icon and/or file name extension and file content.

Additionally in accordance with a preferred embodiment of the present invention the digital object examiner includes a digital object examiner server subsystem, the characteristics mismatch detector includes a mismatch detector server subsystem and the digital object classifier includes a mismatch detector server subsystem.

Still further in accordance with a preferred embodiment of the present invention the digital object examiner includes a digital object examiner client subsystem, the characteristics mismatch detector includes a mismatch detector client subsystem and the digital object classifier includes a mismatch detector client subsystem.

Further in accordance with a preferred embodiment of the present invention the digital object examiner includes a digital object examiner gateway subsystem, the characteristics mismatch detector includes a mismatch detector gateway subsystem and the digital object classifier includes a mismatch detector gateway subsystem.

Preferably, the digital object examiner is selected from a set consisting of: a digital object examiner server subsystem, a digital object examiner client subsystem and a digital object examiner gateway subsystem.

The digital characteristics mismatch detector is preferably selected from a set consisting of: a characteristics mismatch detector server subsystem, a characteristics mismatch detector client subsystem and a characteristics mismatch detector gateway subsystem.

The digital object classifier is preferably selected from a set consisting of: a digital object classifier server subsystem, a digital object classifier client subsystem and a digital object classifier gateway subsystem.

Further in accordance with a preferred embodiment of the present invention the digital object examiner includes a digital object examiner client subsystem the characteristics mismatch detector includes a mismatch detector client subsystem and the digital object classifier includes a mismatch detector client subsystem.

Still further in accordance with a preferred embodiment of the present invention the digital object information obtainer includes a digital object information obtainer server subsystem, the characteristic based categorizer includes a characteristic based categorizer server subsystem, the categories mismatch detector includes a mismatch detector server subsystem and the digital object classifier includes a mismatch detector server subsystem.

Additionally in accordance with a preferred embodiment of the present invention the digital object information obtainer includes a digital object information obtainer client subsystem, the characteristic based categorizer includes a characteristic based categorizer client subsystem, the categories mismatch detector includes a mismatch detector client subsystem and the digital object classifier includes a mismatch detector client subsystem.

Still further in accordance with a preferred embodiment of the present invention the digital object information obtainer includes a digital object information obtainer gateway subsystem, the characteristic based categorizer includes a characteristic based categorizer gateway subsystem, the categories mismatch detector includes a mismatch detector gateway subsystem and the digital object classifier includes a mismatch detector gateway subsystem.

Preferably, the digital object information obtainer is selected from a set consisting of: a digital object information server subsystem, a digital object information client subsystem and a digital object information gateway subsystem.

The characteristic based categorizer is preferably selected from a set consisting of: a characteristic based categorizer server subsystem, a characteristic based categorizer client subsystem and a characteristic based categorizer gateway subsystem.

The categories mismatch detector is preferably selected from a set consisting of: a categories mismatch detector server subsystem, a categories mismatch detector client subsystem and a categories mismatch detector gateway subsystem.

The digital object classifier is preferably selected from a set consisting of: a digital object classifier server subsystem, a digital object classifier client subsystem and a digital object classifier gateway subsystem.

Further in accordance with a preferred embodiment of the present invention the digital object examiner includes a digital object examiner server subsystem, the characteristics mismatch detector includes a mismatch detector server subsystem and the digital object classifier includes a mismatch detector server subsystem.

Additionally in accordance with a preferred embodiment of the present invention the digital object examiner includes a digital object examiner gateway subsystem, the characteristics mismatch detector includes a mismatch detector gateway subsystem and the digital object classifier inlcudes a mismatch detector gateway subsystem.

Preferably, the digital object examiner is selected from a set consisting of: a digital object examiner server subsystem, a digital object examiner client subsystem and a digital object examiner gateway subsystem.

The digital characteristics mismatch detector is preferably selected from a set consisting of: a characteristics mismatch detector server subsystem, a characteristics mismatch detector client subsystem and a characteristics mismatch detector gateway subsystem.

### BRIEF DESCRIPTION OF THE DRAWINGS

The present invention will be understood and appreciated more fully from the following detailed description, taken in conjunction with the drawing in which:

FIG. 1 is a simplified pictorial and symbolic illustration of a message bearing an attachment, which contains malicious content;

FIGS. 2A, 2B and 2C are simplified pictorial and symbolic illustrations of a preferred embodiment of the functionality of FIG. 1, wherein an e-mail attachment is examined to determine at least two characteristics thereof and analyzing the at least two characteristics to determine whether there exists a mismatch therebetween;

FIG. 3 is a simplified pictorial and symbolic illustration of classifying a file containing a mismatch as a file possibly containing malicious content;

FIGS. 4A and 4B are simplified illustrations of comparison of various combinations of more than two characteristics of a file in accordance with a preferred embodiment of the present invention; and

FIGS. 5A, 5B and 5C are simplified block diagrams illustrating three embodiments of a system carrying out the functionality of FIGS. 1-4B.

FIGS. 6A, 6B and 6C are simplified block diagrams illustrating yet another three embodiments of a system carrying out the functionality of FIGS. 1-4B.

### DETAILED DESCRIPTION OF A PREFERRED EMBODIMENT

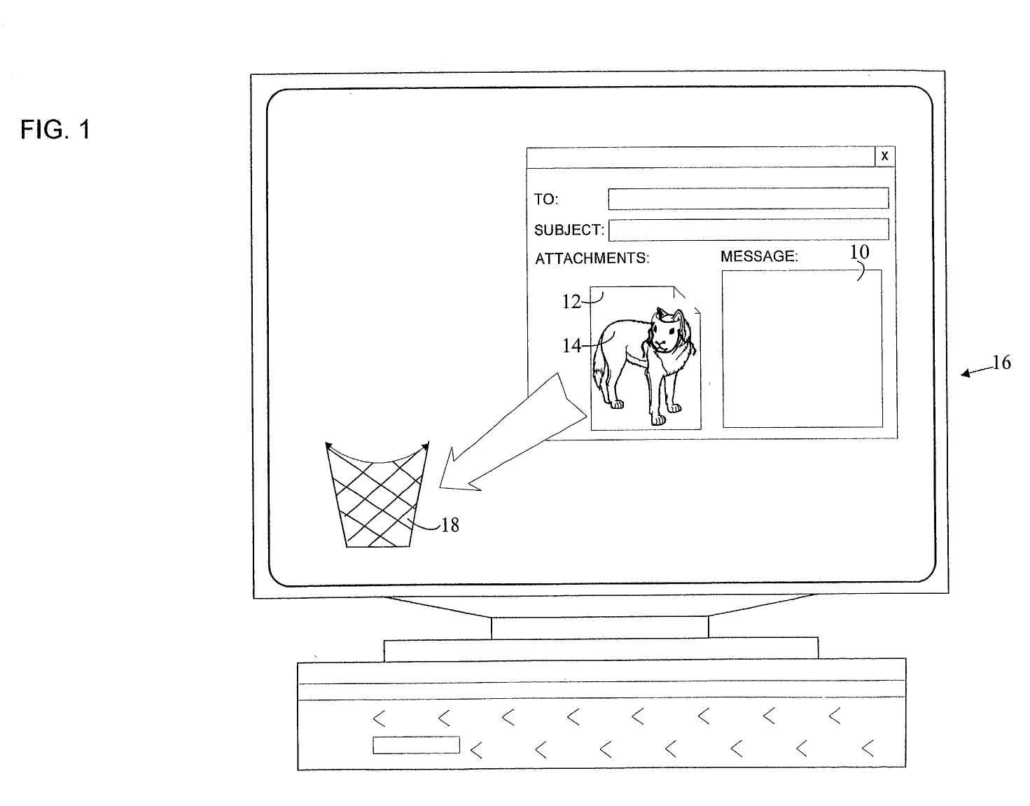

Reference is made to FIG. 1, which is a simplified pictorial and symbolic illustration of treatment of a message bearing an attachment which contains malicious content in accordance with a preferred embodiment of the present invention.

As seen in FIG. 1, a message 10 bearing an attachment 12 which contains malicious content is symbolized by a message having an attachment indicating icon 14, which appears as a wolf wearing a sheep face mask. In accordance with the present invention, the attachment 12 is scrutinized so as to discern that it contains malicious content, e.g. the sheep face is not the face of a sheep but rather a mask hiding a wolf. Such an attachment is discarded and is not allowed to damage a computer 16 or communication system, as symbolized by the illustrated transfer of the attachment to a wastebasket 18

It is appreciated that the present invention is not limited to malicious content in the form of or as part of an e-mail attachment but applies equally to malicious content appearing in any digital object, such as, for example, a file or a web page downloaded from the Internet, a file copied from a diskette or other storage medium or other structured digital object, and to determine the existence of such malicious content by observing a mismatch between at least two characteristics thereof.

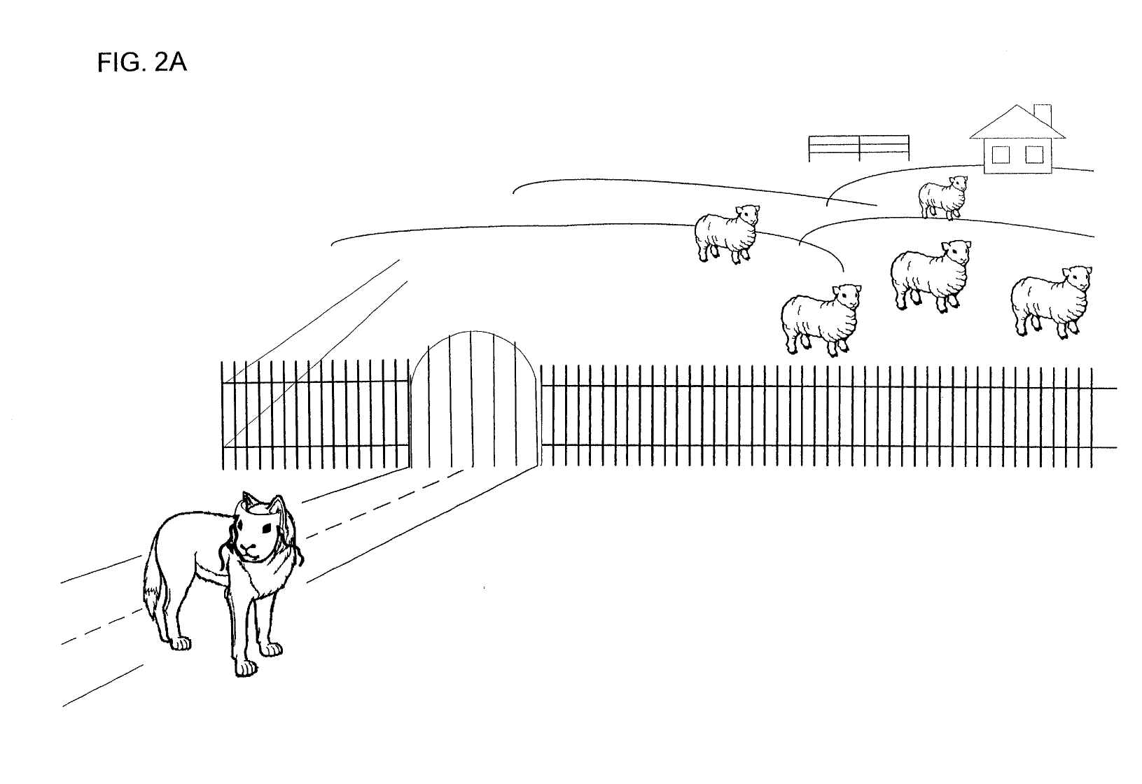

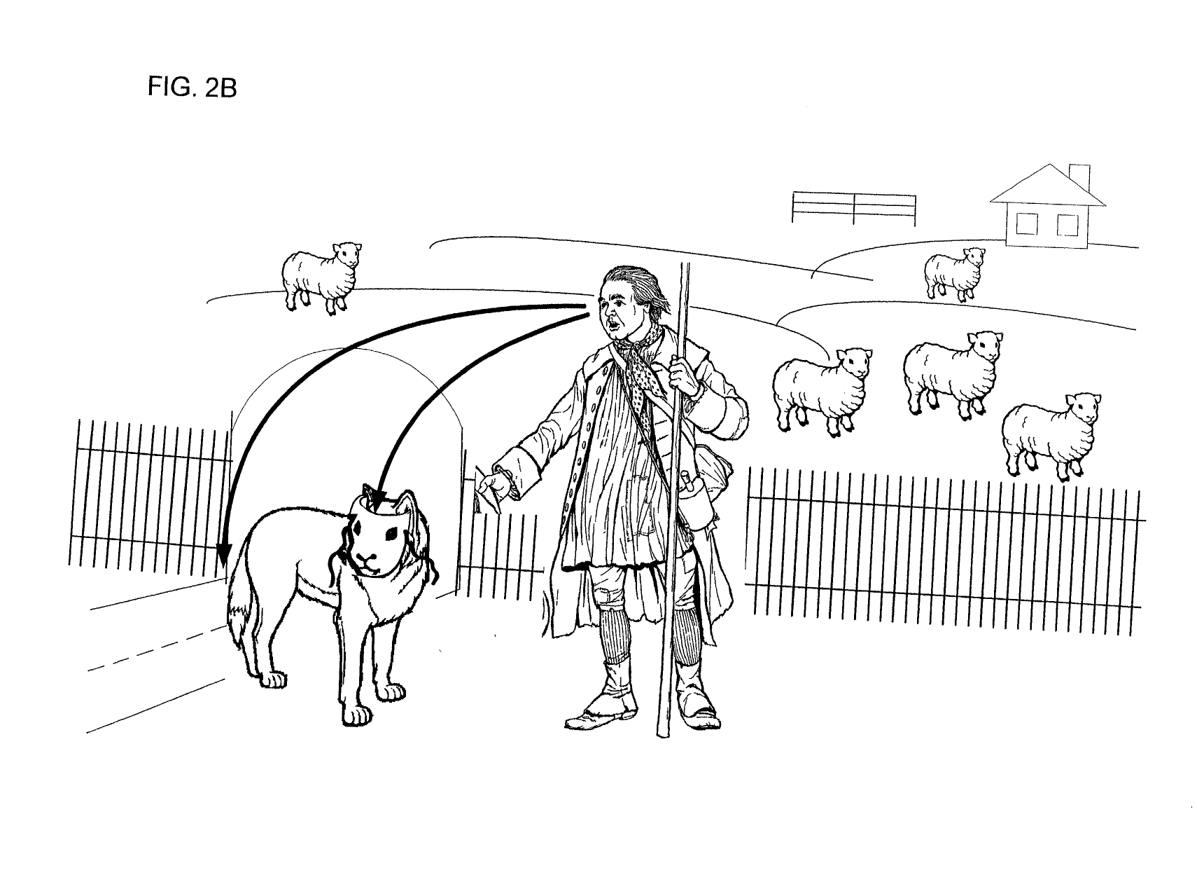

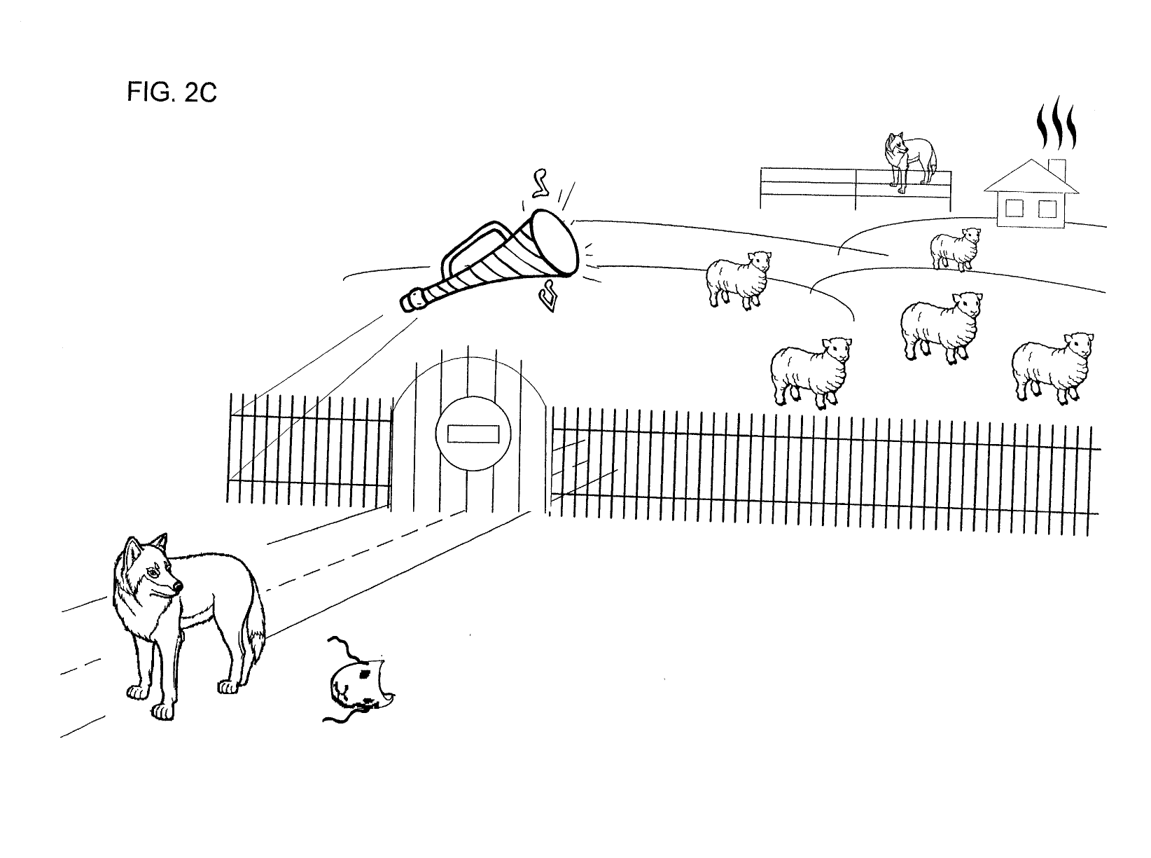

Reference is now made to FIGS. 2A, 2B and 2C which are simplified pictorial and symbolic illustrations of a preferred embodiment of the functionality of FIG. 1, wherein an e-mail attachment is examined to determine at least two characteristics thereof and analyzing the at least two characteristics to determine whether there exists a mismatch therebetween.

As seen in FIG. 2A, an e-mail attachment containing malicious content is symbolized by a wolf wearing a sheep face mask approaching the gate of a fenced-in meadow, which symbolizes a computer network.

FIG. 2B shows the wolf wearing a sheep face mask being inspected by a shepherd prior to being allowed to enter the meadow, which corresponds to inspection of the e-mail attachment by the functionality of FIG. 1. The shepherd inspects at least two separate characteristics of the putative sheep, here the face and the tail, corresponding to two separate characteristics of the e-mail attachment, such as the icon and file name extension.

The shepherd notices that the inspected characteristics do not match each other, i.e. the putative sheep has the face of a sheep and the tail of an animal other than a sheep. This indicates to the shepherd that something is amiss and he denies the putative sheep access to the meadow, as seen in FIG. 2C, representing discarding the e-mail attachment.

Alternatively or additionally, the shepherd may lock up the putative sheep in a corral, which represents a restricted directory, or may issue a visible and/or audio warning, symbolized by blowing on a horn and by smoke signals.

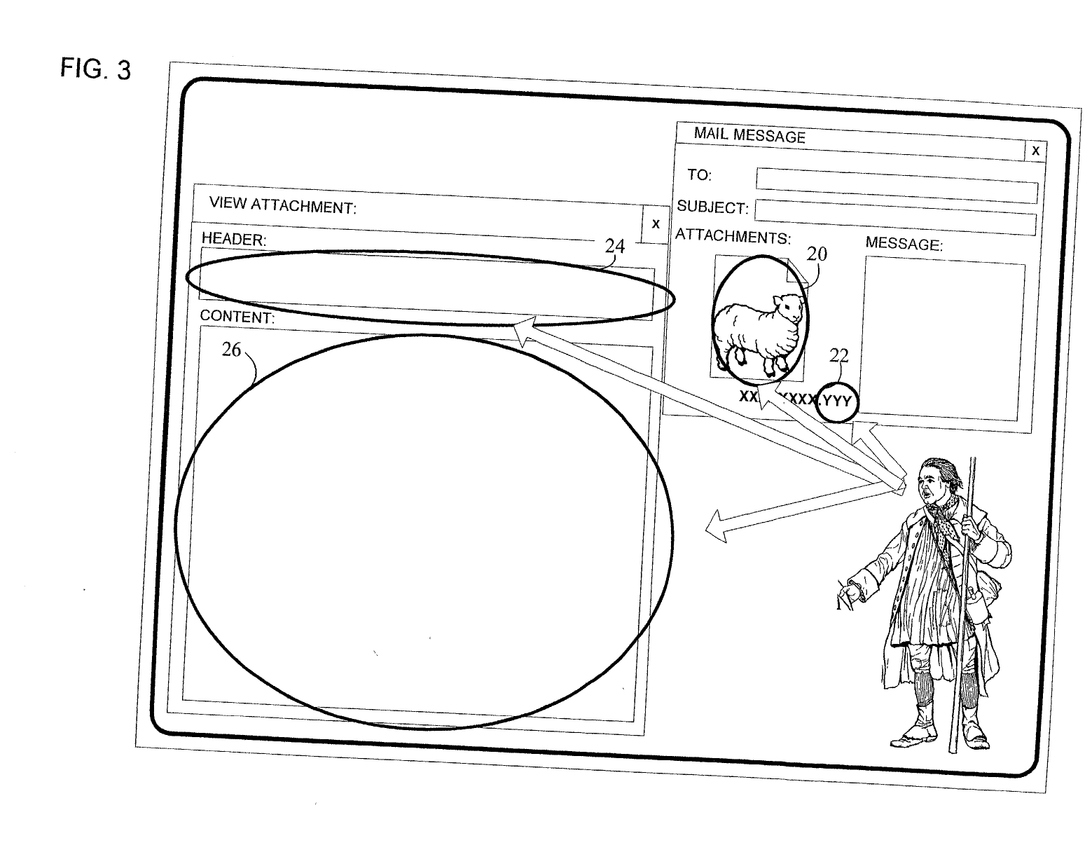

Reference is now made to FIG. 3, which is a simplified pictorial and symbolic illustration of classifying a file containing a mismatch as a file possibly containing malicious content. As seen in FIG. 3, at least two of the following characteristics are inspected for the existence of a mismatch therebetween:

e-mail attachment icon 20;

e-mail attachment name extension 22;

e-mail attachment header 24; and

file content 26.

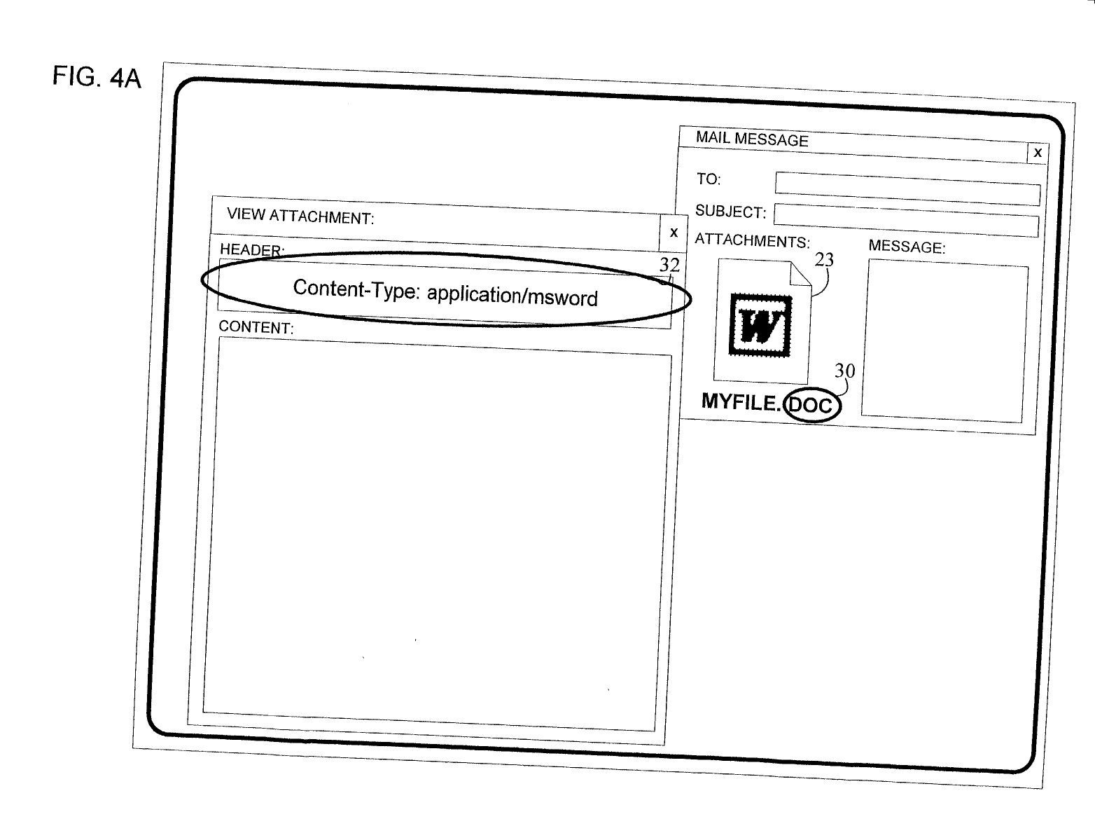

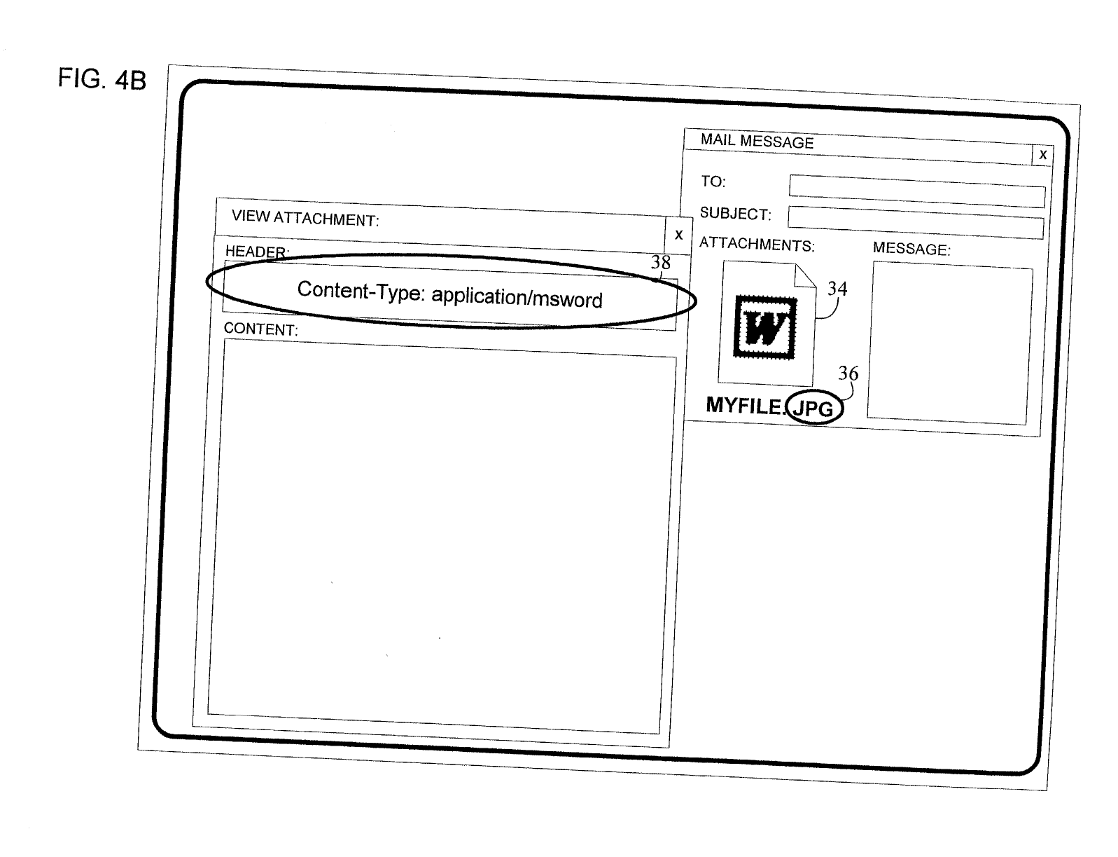

Reference is now made to FIGS. 4A and 4B are simplified illustrations of comparison of various combinations of more than two characteristics of a file in accordance with a preferred embodiment of the present invention.

FIG. 4A illustrates a situation wherein the e-mail attachment icon 28, the e-mail attachment name extension 30 and the e-mail attachment header 32 all match each other. This indicates the absence of malicious content.

FIG. 4B illustrates a situation wherein the e-mail attachment icon 34 and the e-mail attachment header match 36 each other, but do not match the e-mail attachment name extension 38. This indicates the presence of malicious content.

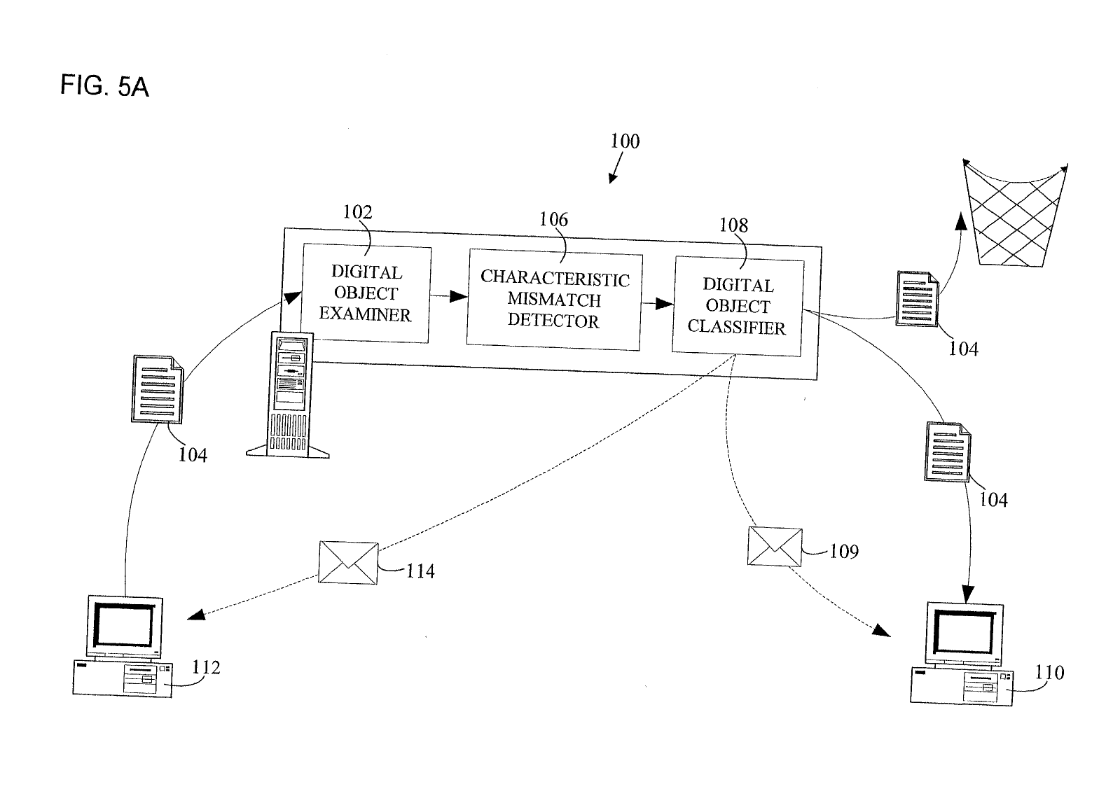

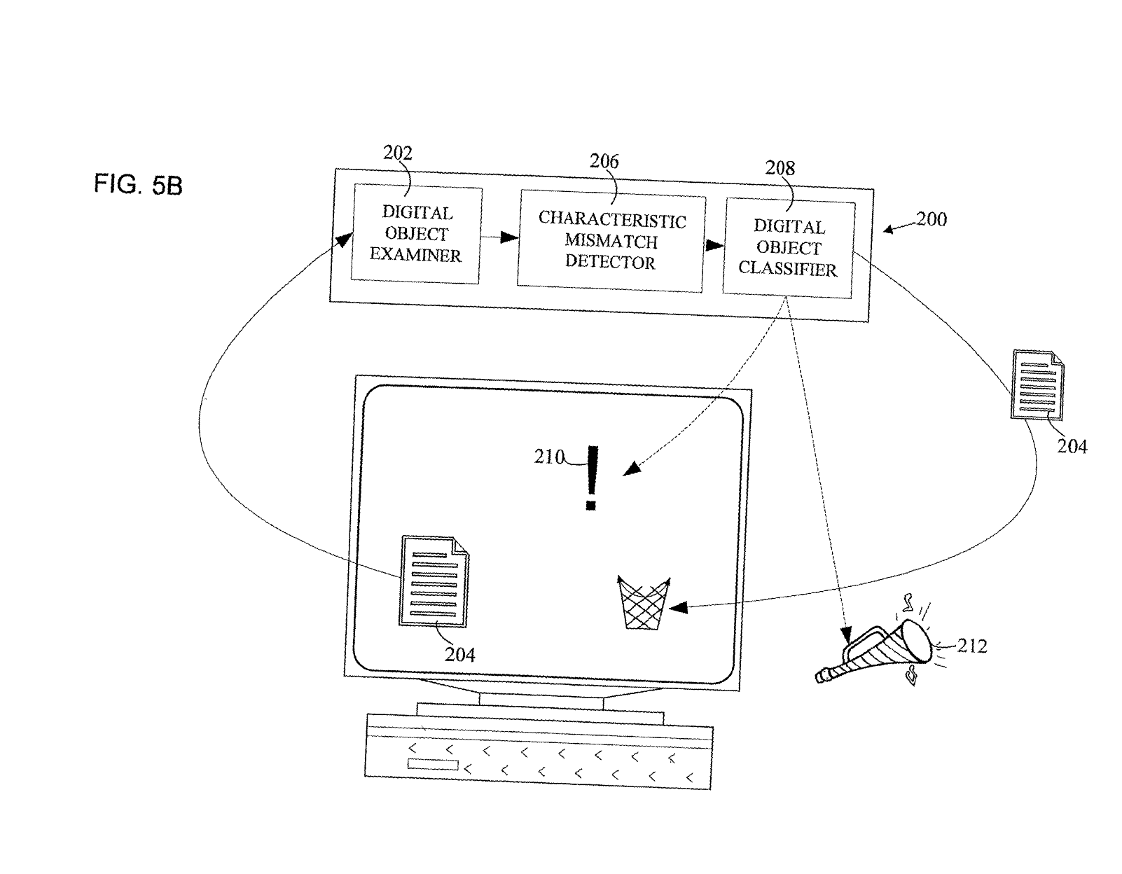

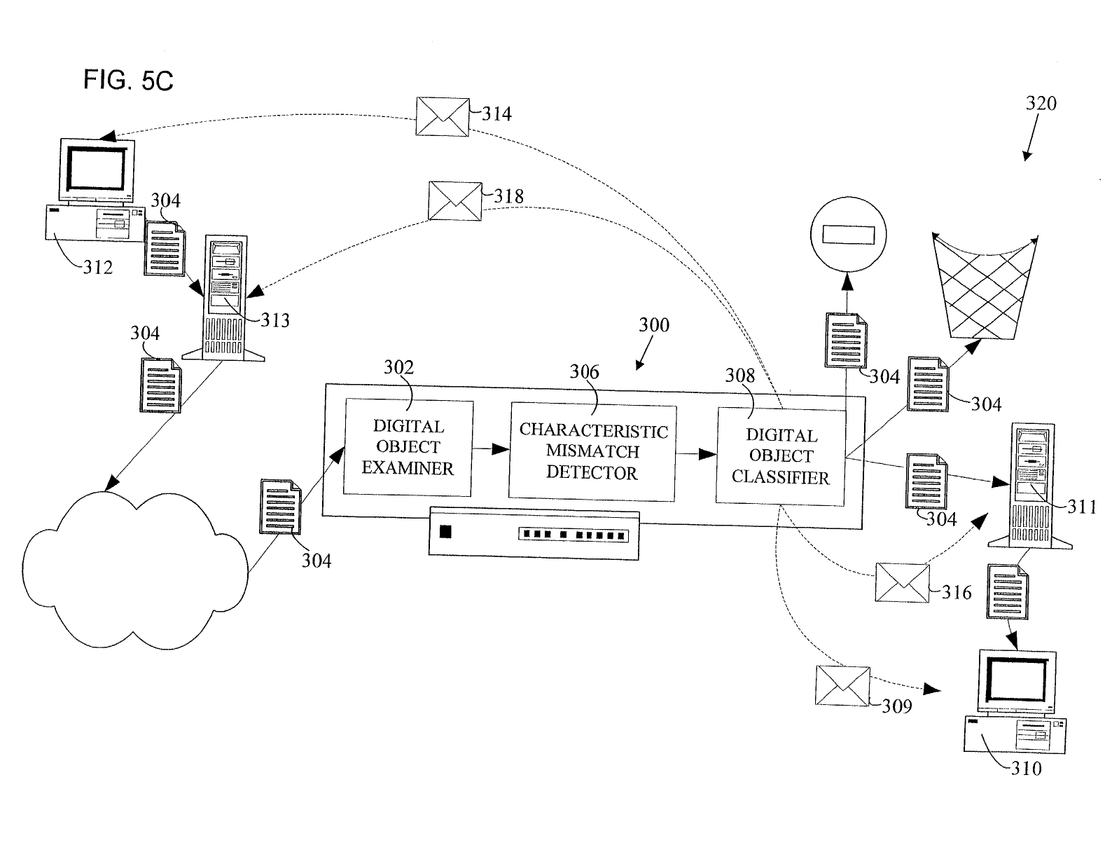

Reference is now made to FIGS. 5A, 5B and 5C, which are simplified block diagrams illustrating three embodiments of a system carrying out the functionality of FIGS. 1-4B.

FIG. 5A, which illustrates the system of the present invention in a server environment, shows a system 100 for detecting malicious content which comprises a digital object examiner server subsystem 102, examining at least two characteristics of a digital object 104. A characteristic mismatch detector server subsystem 106 receives an output from the digital object examiner server subsystem 102 and analyzes the at least two characteristics to determine whether there exists a mismatch therebetween.

A digital object classifier server subsystem 108 receives an output from the characteristic mismatch detector server subsystem 106 and is operative upon determination of the existence of a mismatch for classifying the digital object 104 as a digital object possibly containing malicious content. Subsystem 108 may then send a suitable notification 109, as well as the digital object 104, to a client 110 to whom the digital object 104 was directed. Subsystem 108 may, alternatively or additionally, send a suitable notification 114 to a client 112 from whom the digital object was received. Alternatively or additionally, subsystem 108 may discard the digital object 104.

FIG. 5B, which illustrates the system of the present invention in a client environment, shows a system 200 for detecting malicious content which comprises a digital object examiner client subsystem 202, examining at least two characteristics of a digital object 204. A characteristic mismatch detector client subsystem 206 receives an output from the digital object examiner client subsystem 202 and analyzes the at least two characteristics to determine whether there exists a mismatch therebetween.

A digital object classifier client subsystem 208 receives an output from the characteristic mismatch detector client subsystem 206 and is operative upon determination of the existence of a mismatch for classifying the digital object 204 as a digital object possibly containing malicious content. Subsystem 208 may then display a suitable visible notification 210 and/or make a suitable audible notification 212 to the user of the client environment. Subsystem 208 may alternatively or additionally discard the digital object 204.

FIG. 5C, which illustrates the system of the present invention in a gateway environment, shows a system 300 for detecting malicious content which comprises a digital object examiner gateway subsystem 302, examining at least two characteristics of a digital object 304. A characteristic mismatch detector gateway subsystem 306 receives an output from the digital object examiner gateway subsystem 302 and analyzes the at least two characteristics to determine whether there exists a mismatch therebetween.

A digital object classifier gateway subsystem 308 receives an output from the characteristic mismatch detector gateway subsystem 306 and is operative upon determination of the existence of a mismatch for classifying the digital object 304 as a digital object possibly containing malicious content. Subsystem 308 may then send a suitable notification 309 to a client 310 and/or a suitable notification 316 to the server 311 to which the digital object 304 was directed. Additionally or alternatively, the subsystem 308 may send the digital object 304 to the server 311. Subsystem 308 may, alternatively or additionally, send a suitable notification 314 to a client 312 and/or a suitable notification 318 to the server 313 from whom the digital object 304 was received. Subsystem 308 may alternatively or additionally discard the digital object 304. Alternatively or additionally, subsystem 308 may prevent the digital object 304 from entering a network 320.

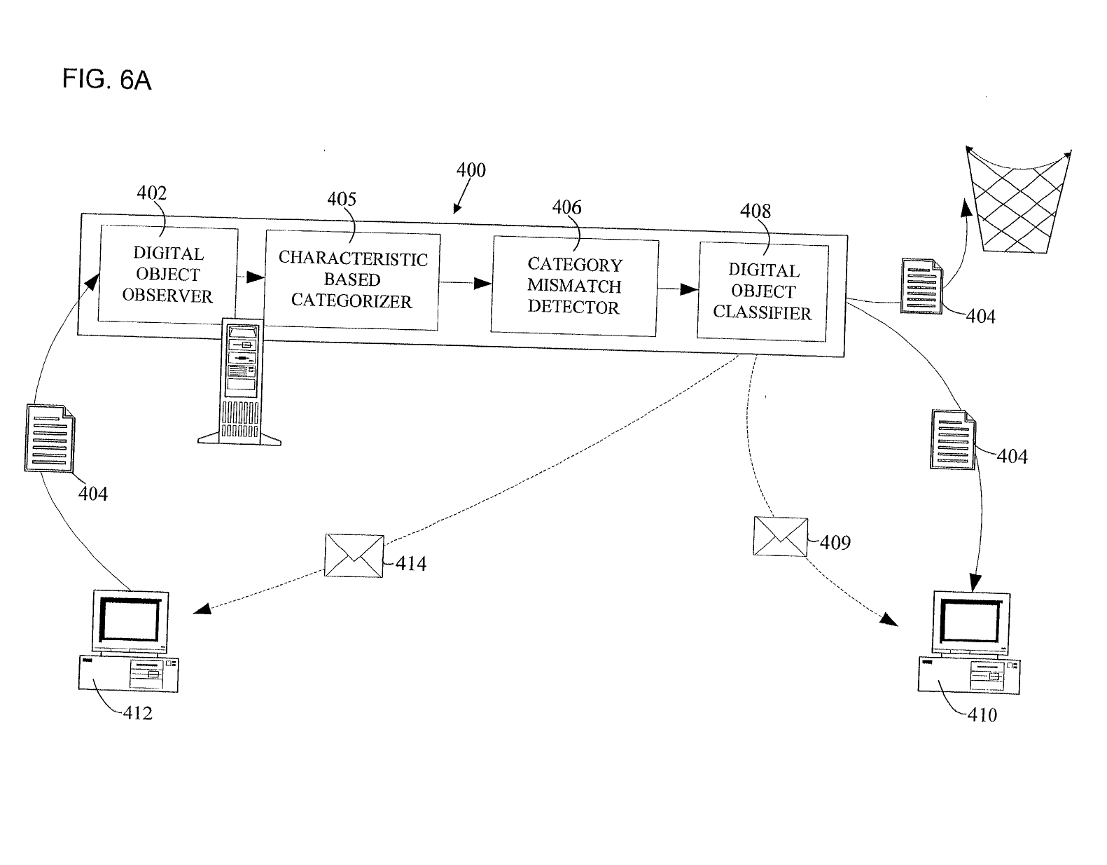

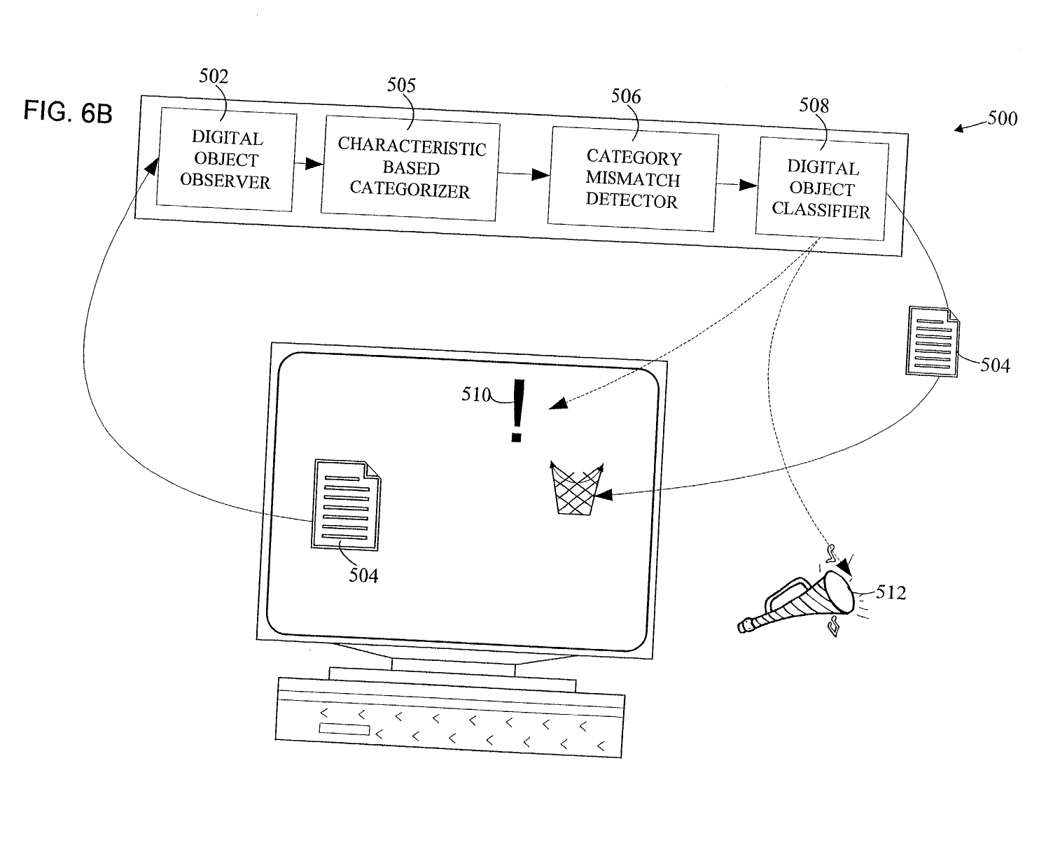

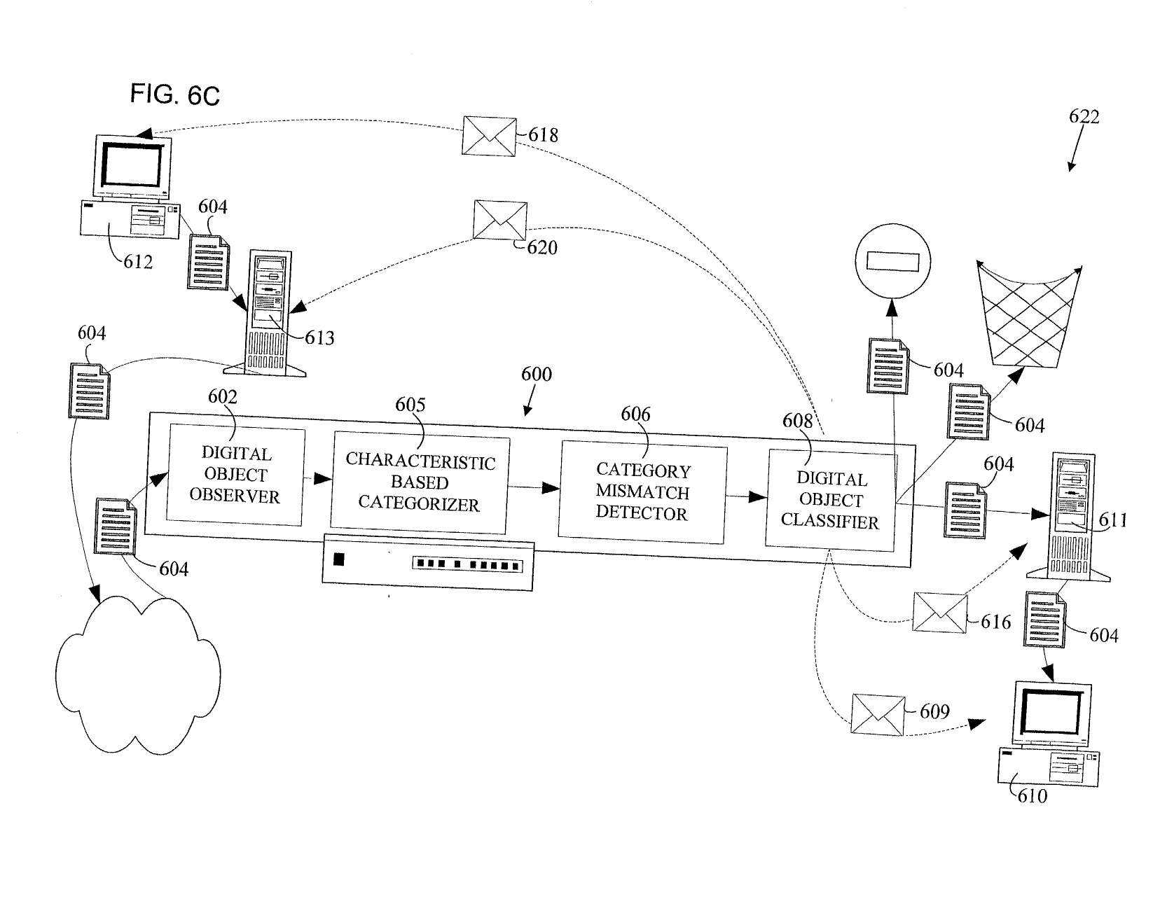

Reference is now made to FIGS. 6A, 6B and 6C, which are simplified block diagrams illustrating yet another three embodiments of a system carrying out the functionality of FIGS. 1-4B.

FIG. 6A, which illustrates the system of the present invention in a server environment, shows a system 400 for detecting malicious content which comprises a digital object observer server subsystem 402, observing at least two characteristics of a digital object 404. A characteristic based categorizer server subsystem 405 receives an output from the digital object observer server subsystem 402 and analyzes each one of the at least two characteristics in order to categorize the digital object in a category, such as a file type, indicated by that characteristic. A category mismatch detector server subsystem 406 receives an output from the characteristic based categorizer server subsystem 405 and compares the various categories indicated by the various characteristics in order to determine whether there exists a mismatch between the categories.

A digital object classifier server subsystem 408 receives an output from the category mismatch detector server subsystem 406 and is operative upon determination of the existence of a category mismatch for classifying the digital object 404 as a digital object possibly containing malicious content. Subsystem 408 may then send a suitable notification 409 to a client 410 to whom the digital object 404 was directed. Subsystem 408 may, alternatively or additionally, send a suitable notification 414 to a client 412 from whom the digital object was received. Alternatively or additionally, subsystem 408 may discard the digital object 404.

FIG. 6B, which illustrates the system of the present invention in a client environment, shows a system 500 for detecting malicious content which comprises a digital object observer client subsystem 502, examining at least two characteristics of a digital object 504. A characteristic based categorizer client subsystem 505 receives an output from the digital object observer client subsystem 502 and analyzes any one of the at least two characteristics to determine a category characteristic, such as a file type, of the digital object according to any one of the at least two examined characteristics. A category mismatch detector client subsystem 506 receives an output from the characteristic based categorizer client subsystem 505 and analyzes the determined category characteristics to decide whether there exists a mismatch therebetween.

A digital object classifier client subsystem 508 receives an output from the category mismatch detector client subsystem 506 and is operative upon determination of the existence of a mismatch for classifying the digital object 504 as a digital object possibly containing malicious content. Subsystem 508 may then display a suitable visible notification 510 and/or make a suitable audible notification 512 to the user of the client environment. Subsystem 508 may alternatively or additionally discard the digital object 504.

FIG. 6C, which illustrates the system of the present invention in a gateway environment, shows a system 600 for detecting malicious content which comprises a digital object observer gateway subsystem 602, examining at least two characteristics of a digital object 604. A characteristic based categorizer gateway subsystem 605 receives an output from the digital object observer gateway subsystem 602 and analyzes any one of the at least two characteristics to determine a category characteristics such as a file type, of the digital object according to any one of the at least two examined characteristics. A category mismatch detector gateway subsystem 606 receives an output from the characteristic based categorizer gateway subsystem 605 and analyzes the determined category characteristics to decide whether there exists a mismatch therebetween.

A digital object classifier gateway subsystem 608 receives an output from the category mismatch detector gateway subsystem 606 and is operative upon determination of the existence of a category mismatch for classifying the digital object 604 as a digital object possibly containing malicious content. Subsystem 608 may then send a suitable notification 609 to a client 610 and/or a suitable notification 616 to the server 611 to which the digital object was directed. Subsystem 608 may, alternatively or additionally, send a suitable notification 618 to a client 612 and/or a suitable notification 620 to a server 613 from whom the digital object 604 was received. Additionally or alternatively, the subsystem 608 may send the digital object 604 to the server 611, which may then pass the digital object 604 to the client 610. Subsystem 608 may, alternatively or additionally, discard the digital object 604. Alternatively or additionally, subsystem 608 may prevent the digital object 604 from entering a network 622.

It will be appreciated by persons skilled in the art that the present invention is not limited by what has been particularly shown and described hereinabove. Rather the scope of the present invention includes both combinations and subcombinations of the various characteristics described hereinabove as well as variations and modifications which would occur to persons skilled in the art upon reading the specification and which are not in the prior art.

1. A method of detecting malicious content comprising:
examining at least two characteristics of a digital object;
analyzing said at least two characteristics to determine whether there exists a mismatch therebetween; and
upon determination of the existence of a mismatch, classifying said digital object as a digital object possibly containing malicious content.

2. A method for detecting malicious content according to claim 1 and wherein said malicious content comprises malicious code.

3. A method for detecting malicious content according to claim 1 and wherein said malicious content comprises masqueraded content.

4. A method for detecting malicious content according to claim 1 and wherein at least one of said at least two characteristics is selected from a set consisting of:
header information;
file content;
file name extension; and
file icon.

5. A method for detecting malicious content according to claim 4 and wherein said malicious content comprises malicious code.

6. A method for detecting malicious content according to claim 4 and wherein said malicious content comprises masqueraded content.

7. A method for detecting malicious content according to claim 1 and wherein said digital object is selected from a set consisting of:
a file;
an e-mail attachment;
a web page; and
a storage medium.

8. A method for detecting malicious content according to claim 7 and wherein said malicious content comprises malicious code.

9. A method for detecting malicious content according to claim 7 and wherein said malicious content comprises masqueraded content.

10. A method for detecting malicious content according to claim 7 and wherein at least one of said at least two characteristics is selected from a set consisting of:
header information;
file content;
file name extension; and
file icon.

11. A method for detecting malicious content according to claim 10 and wherein said malicious content comprises malicious code.

12. A method for detecting malicious content according to claim 10 and wherein said malicious content comprises masqueraded content.

13. A method for detecting malicious content according to claim 1 and wherein said digital object comprises a file.

14. A method for detecting malicious content according to claim 1 and wherein said digital object comprises an e-mail attachment.

15. A method for detecting malicious content according to claim 1 and wherein said digital object comprises a web page.

16. A method for detecting malicious content according to claim 1 and wherein said digital object comprises a storage medium.

17. A method for detecting malicious content according to claim 1 and wherein said at least two characteristics comprise:
header information; and
file content.

18. A method for detecting malicious content according to claim 1 and wherein said at least two characteristics comprise:
header information; and
file name extension.

19. A method for detecting malicious content according to claim 1 and wherein said at least two characteristics comprise:
header information; and
file icon.

20. A method for detecting malicious content according to claim 1 and wherein said at least two characteristics comprise:
file content; and
file icon.

21. A method for detecting malicious content according to claim 1 and wherein said at least two characteristics comprise:
file name extension; and
file icon.

22. A method for detecting malicious content according to claim 1 and wherein said at least two characteristics comprise:
file name extension; and
file content.

23. A method of detecting malicious content comprising:
obtaining information relating to at least two characteristics of a digital object;
analyzing said information to categorize said digital object into at least two categories;
comparing said at least two categories to decide whether there exists a mismatch therebetween;
upon determination of the existence of a mismatch, classifying said digital object as a digital object possibly containing malicious content.

24. A method for detecting malicious content according to claim 23 and wherein said malicious content comprises malicious code.

25. A method for detecting malicious content according to claim 23 and wherein said malicious content comprises masqueraded content.

26. A method for detecting malicious content according to claim 23 and wherein at least one of said at least two characteristics is selected from a set consisting of:
header information;
file content;
file name extension; and
file icon.

27. A method for detecting malicious content according to claim 26 and wherein said malicious content comprises malicious code.

28. A method for detecting malicious content according to claim 26 and wherein said malicious content comprises masqueraded content.

29. A method for detecting malicious content according to claim 23 and wherein said digital object is selected from a set consisting of:
a file;
an e-mail attachment;
a web page; and
a storage medium.

30. A method for detecting malicious content according to claim 29 and wherein said malicious content comprises malicious code.

31. A method for detecting malicious content according to claim 29 and wherein said malicious content comprises masqueraded content.

32. A method for detecting malicious content according to claim 29 and wherein at least one of said at least two characteristics is selected from a set consisting of:
header information;
file content;
file name extension; and
file icon.

33. A method for detecting malicious content according to claim 32 and wherein said malicious content comprises malicious code.

34. A method for detecting malicious content according to claim 32 and wherein said malicious content comprises masqueraded content.

35. A method for detecting malicious content according to claim 23 and wherein said digital object comprises a file.

36. A method for detecting malicious content according to claim 23 and wherein said digital object comprises an e-mail attachment.

37. A method for detecting malicious content according to claim 23 and wherein said digital object comprises a web page.

38. A method for detecting malicious content according to claim 23 and wherein said digital object comprises a storage medium.

39. A method for detecting malicious content according to claim 23 and wherein said at least two characteristics comprise:
header information; and
file content.

40. A method for detecting malicious content according to claim 23 and wherein said at least two characteristics comprise:
header information; and
file name extension.

41. A method for detecting malicious content according to claim 23 and wherein said at least two characteristics comprise:
header information; and
file icon.

42. A method for detecting malicious content according to claim 23 and wherein said at least two characteristics comprise:
file content; and
file icon.

43. A method for detecting malicious content according to claim 23 and wherein said at least two characteristics comprise:
file name extension; and
file icon.

44. A method for detecting malicious content according to claim 23 and wherein said at least two characteristics comprise:
file name extension; and
file content.

45. A method of detecting malicious content comprising:
examining at least two characteristics of a digital object, each of which characteristics may be selected by a creator of the digital object independently of selection of another characteristic;
analyzing said at least two characteristics to determine whether there exists a mismatch therebetween; and
upon determination of the existence of a mismatch, classifying said digital object as a digital object possibly containing malicious content.

46. A method for detecting malicious content according to claim 45 and wherein said malicious content comprises malicious code.

47. A method for detecting malicious content according to claim 45 and wherein said malicious content comprises masqueraded content.

48. A method for detecting malicious content according to claim 45 and wherein at least one of said at least two characteristics is selected from a set consisting of:
header information;
file content;
file name extension; and
file icon.

49. A method for detecting malicious content according to claim 48 and wherein said malicious content comprises malicious code.

50. A method for detecting malicious content according to claim 48 and wherein said malicious content comprises masqueraded content.

51. A method for detecting malicious content according to claim 45 and wherein said digital object is selected from a set consisting of:
a file;
an e-mail attachment;
a web page; and
a storage medium.

52. A method for detecting malicious content according to claim 51 and wherein said malicious content comprises malicious code.

53. A method for detecting malicious content according to claim 51 and wherein said malicious content comprises masqueraded content.

54. A method for detecting malicious content according to claim 51 and wherein at least one of said at least two characteristics is selected from a set consisting of:
header information;
file content;
file name extension; and
file icon.

55. A method for detecting malicious content according to claim 54 and wherein said malicious content comprises malicious code.

56. A method for detecting malicious content according to claim 54 and wherein said malicious content comprises masqueraded content.

57. A method for detecting malicious content according to claim 45 and wherein said digital object comprises a file.

58. A method for detecting malicious content according to claim 45 and wherein said digital object comprises an e-mail attachment.

59. A method for detecting malicious content according to claim 45 and wherein said digital object comprises a web page.

60. A method for detecting malicious content according to claim 45 and wherein said digital object comprises a storage medium.

61. A method for detecting malicious content according to claim 45 and wherein said at least two characteristics comprise:
header information; and
file content.

62. A method for detecting malicious content according to claim 45 and wherein said at least two characteristics comprise:
header information; and
file name extension.

63. A method for detecting malicious content according to claim 45 and wherein said at least two characteristics comprise:
header information; and
file icon.

64. A method for detecting malicious content according to claim 45 and wherein said at least two characteristics comprise:
file content; and
file icon.

65. A method for detecting malicious content according to claim 45 and wherein said at least two characteristics comprise:
file name extension; and
file icon.

66. A method for detecting malicious content according to claim 45 and wherein said at least two characteristics comprise:
file name extension; and
file content.

67. A system for detecting malicious content comprising:
a digital object examiner, examining at least two characteristics of a digital object;
a characteristics mismatch detector, analyzing said at least two characteristics to determine whether there exists a mismatch therebetween; and
a digital object classifier, operative upon determination of the existence of a mismatch, classifying said digital object as a digital object possibly containing malicious content.

68. A system for detecting malicious content according to claim 67 and wherein said malicious content comprises malicious code.

69. A system for detecting malicious content according to claim 67 and wherein said malicious content comprises masqueraded content.

70. A system for detecting malicious content according to claim 67 and wherein at least one of said at least two characteristics is selected from a set consisting of:
header information;
file content;
file name extension; and
file icon.

71. A system for detecting malicious content according to claim 70 and wherein said malicious content comprises malicious code.

72. A system for detecting malicious content according to claim 70 and wherein said malicious content comprises masqueraded content.

73. A system for detecting malicious content according to claim 67 and wherein said digital object is selected from a set consisting of:
a file;
an e-mail attachment;
a web page; and
a storage medium.

74. A system for detecting malicious content according to claim 73 and wherein said malicious content comprises malicious code.

75. A system for detecting malicious content according to claim 73 and wherein said malicious content comprises masqueraded content.

76. A system for detecting malicious content according to claim 73 and wherein at least one of said at least two characteristics is selected from a set consisting of:
header information;
file content;
file name extension; and
file icon.

77. A system for detecting malicious content according to claim 76 and wherein said malicious content comprises malicious code.

78. A system for detecting malicious content according to claim 76 and wherein said malicious content comprises masqueraded content.

79. A system for detecting malicious content according to claim 67 and wherein said digital object comprises a file.

80. A system for detecting malicious content according to claim 67 and wherein said digital object comprises an e-mail attachment.

81. A system for detecting malicious content according to claim 67 and wherein said digital object comprises a web page.

82. A system for detecting malicious content according to claim 67 and wherein said digital object comprises a storage medium.

83. A system for detecting malicious content according to claim 67 and wherein said at least two characteristics comprise:
header information; and
file content.

84. A system for detecting malicious content according to claim 67 and wherein said at least two characteristics comprise:
header information; and
file name extension.

85. A system for detecting malicious content according to claim 67 and wherein said at least two characteristics comprise:
header information; and
file icon.

86. A system for detecting malicious content according to claim 67 and wherein said at least two characteristics comprise:
file content; and
file icon.

87. A system for detecting malicious content according to claim 67 and wherein said at least two characteristics comprise:
file name extension; and
file icon.

88. A system for detecting malicious content according to claim 67 and wherein said at least two characteristics comprise:
file name extension; and
file content.

89. A system according to claim 67 and wherein:
said digital object examiner comprises a digital object examiner server subsystem;
said characteristics mismatch detector comprising a mismatch detector server subsystem; and
said digital object classifier comprising a mismatch detector server subsystem.

90. A system for detecting malicious content according to claim 89 and wherein said malicious content comprises malicious code.

91. A system for detecting malicious content according to claim 89 and wherein said malicious content comprises masqueraded content.

92. A system for detecting malicious content according to claim 89 and wherein at least one of said at least two characteristics is selected from a set consisting of:
header information;
file content;
file name extension; and
file icon.

93. A system for detecting malicious content according to claim 92 and wherein said malicious content comprises malicious code.

94. A system for detecting malicious content according to claim 92 and wherein said malicious content comprises masqueraded content.

95. A system for detecting malicious content according to claim 89 and wherein said digital object is selected from a set consisting of:
a file;
an e-mail attachment;
a web page; and
a storage medium.

96. A system for detecting malicious content according to claim 95 and wherein said malicious content comprises malicious code.

97. A system for detecting malicious content according to claim 95 and wherein said malicious content comprises masqueraded content.

98. A system for detecting malicious content according to claim 95 and wherein at least one of said at least two characteristics is selected from a set consisting of:
header information;
file content;
file name extension; and
file icon.

99. A system for detecting malicious content according to claim 98 and wherein said malicious content comprises malicious code.

100. A system for detecting malicious content according to claim 98 and wherein said malicious content comprises masqueraded content.

101. A system according to claim 67 and wherein:
said digital object examiner comprises a digital object examiner client subsystem;
said characteristics mismatch detector comprising a mismatch detector client subsystem; and
said digital object classifier comprising a mismatch detector client subsystem.

102. A system for detecting malicious content according to claim 101 and wherein said malicious content comprises malicious code.

103. A system for detecting malicious content according to claim 101 and wherein said malicious content comprises masqueraded content.

104. A system for detecting malicious content according to claim 101 and wherein at least one of said at least two characteristics is selected from a set consisting of:
header information;
file content;
file name extension; and
file icon.

105. A system for detecting malicious content according to claim 104 and wherein said malicious content comprises malicious code.

106. A system for detecting malicious content according to claim 105 and wherein said malicious content comprises masqueraded content.

107. A system for detecting malicious content according to claim 101 and wherein said digital object is selected from a set consisting of:
a file;
an e-mail attachment;
a web page; and
a storage medium.

108. A system for detecting malicious content according to claim 107 and wherein said malicious content comprises malicious code.

109. A system for detecting malicious content according to claim 107 and wherein said malicious content comprises masqueraded content.

110. A system for detecting malicious content according to claim 107 and wherein at least one of said at least two characteristics is selected from a set consisting of:
header information;
file content;
file name extension; and
file icon.

111. A system for detecting malicious content according to claim 110 and wherein said malicious content comprises malicious code.

112. A system for detecting malicious content according to claim 110 and wherein said malicious content comprises masqueraded content.

113. A system according to claim 67 and wherein:
said digital object examiner comprises a digital object examiner gateway subsystem:
said characteristics mismatch detector comprising a mismatch detector gateway subsystem; and
said digital object classifier comprising a mismatch detector gateway subsystem.

114. A system for detecting malicious content according to claim 113 and wherein said malicious content comprises malicious code.

115. A system for detecting malicious content according to claim 113 and wherein said malicious content comprises masqueraded content.

116. A system for detecting malicious content according to claim 113 and wherein at least one of said at least two characteristics is selected from a set consisting of:
header information;
file content;
file name extension; and
file icon.

117. A system for detecting malicious content according to claim 116 and wherein said malicious content comprises malicious code.

118. A system for detecting malicious content according to claim 116 and wherein said malicious content comprises masqueraded content.

119. A system for detecting malicious content according to claim 113 and wherein said digital object is selected from a set consisting of:
a file;
an e-mail attachment;
a web page; and
a storage medium.

120. A system for detecting malicious content according to claim 119 and wherein said malicious content comprises malicious code.

121. A system for detecting malicious content according to claim 119 and wherein said malicious content comprises masqueraded content.

122. A system for detecting malicious content according to claim 119 and wherein at least one of said at least two characteristics is selected from a set consisting of:
header information;
file content;
file name extension; and
file icon.

123. A system for detecting malicious content according to claim 122 and wherein said malicious content comprises malicious code.

124. A system for detecting malicious content according to claim 122 and wherein said malicious content comprises masqueraded content.

125. A system according to claim 67 and wherein:
said digital object examiner is selected from a set consisting of:
a digital object examiner server subsystem;
a digital object examiner client subsystem;
a digital object examiner gateway subsystem;
said digital characteristics mismatch detector is selected from a set consisting of:
a characteristics mismatch detector server subsystem;
a characteristics mismatch detector client subsystem;
a characteristics mismatch detector gateway subsystem; and
said digital object classifier is selected from a set consisting of:
a digital object classifier server subsystem;
a digital object classifier client subsystem;
a digital object classifier gateway subsystem.

126. A system for detecting malicious content comprising:
a digital object information obtainer, obtaining information related to at least two characteristics of a digital object;
a characteristic based categorizer, categorizing said information into at least two categories;
a categories mismatch detector, analyzing said at least two categories to determine whether there exists a mismatch therebetween; and
a digital object classifier, operative upon determination of the existence of a mismatch, classifying said digital object as a digital object possibly containing malicious content.

127. A system for detecting malicious content according to claim 126 and wherein said malicious content comprises malicious code.

128. A system for detecting malicious content according to claim 126 and wherein said malicious content comprises masqueraded content.

129. A system for detecting malicious content according to claim 126 and wherein at least one of said at least two characteristics is selected from a set consisting of:
header information;
file content;
file name extension; and
file icon.

130. A system for detecting malicious content according to claim 129 and wherein said malicious content comprises malicious code.

131. A system for detecting malicious content according to claim 129 and wherein said malicious content comprises masqueraded content.

132. A system for detecting malicious content according to claim 126 and wherein said digital object is selected from a set consisting of:
a file;
an e-mail attachment;
a web page; and
a storage medium.

133. A system for detecting malicious content according to claim 132 and wherein said malicious content comprises malicious code.

134. A system for detecting malicious content according to claim 132 and wherein said malicious content comprises masqueraded content.

135. A system for detecting malicious content according to claim 132 and wherein at least one of said at least two characteristics is selected from a set consisting of:
header information;
file content;
file name extension; and
file icon.

136. A system for detecting malicious content according to claim 135 and wherein said malicious content comprises malicious code.

137. A system for detecting malicious content according to claim 135 and wherein said malicious content comprises masqueraded content.

138. A system for detecting malicious content according to claim 126 and wherein said digital object comprises a file.

139. A system for detecting malicious content according to claim 126 and wherein said digital object comprises an e-mail attachment.

140. A system for detecting malicious content according to claim 126 and wherein said digital object comprises a web page.

141. A system for detecting malicious content according to claim 126 and wherein said digital object comprises a storage medium.

142. A system for detecting malicious content according to claim 126 and wherein said at least two characteristics comprise:
header information; and
file content.

143. A system for detecting malicious content according to claim 126 and wherein said at least two characteristics comprise:
header information; and
file name extension.

144. A system for detecting malicious content according to claim 126 and wherein said at least two characteristics comprise:
header information; and
file icon.

145. A system for detecting malicious content according to claim 126 and wherein said at least two characteristics comprise:
file content; and
file icon.

146. A system for detecting malicious content according to claim 126 and wherein said at least two characteristics comprise:
file name extension; and
file icon.

147. A system for detecting malicious content according to claim 126 and wherein said at least two characteristics comprise:
file name extension; and
file content.

148. A system according to claim 126 and wherein:
said digital object information obtainer comprises a digital object information obtainer server subsystem;
said characteristic based categorizer comprises a characteristic based categorizer server subsystem;
said categories mismatch detector comprising a mismatch detector server subsystem; and
said digital object classifier comprising a mismatch detector server subsystem.

149. A system for detecting malicious content according to claim 148 and wherein said malicious content comprises malicious code.

150. A system for detecting malicious content according to claim 148 and wherein said malicious content comprises masqueraded content.

151. A system for detecting malicious content according to claim 148 and wherein at least one of said at least two characteristics is selected from a set consisting of:
header information;
file content;
file name extension; and
file icon.

152. A system for detecting malicious content according to claim 151 and wherein said malicious content comprises malicious code.

153. A system for detecting malicious content according to claim 151 and wherein said malicious content comprises masqueraded content.

154. A system for detecting malicious content according to claim 148 and wherein said digital object is selected from a set consisting of:
a file;
an e-mail attachment;
a web page; and
a storage medium.

155. A system for detecting malicious content according to claim 154 and wherein said malicious content comprises malicious code.

156. A system for detecting malicious content according to claim 154 and wherein said malicious content comprises masqueraded content.

157. A system for detecting malicious content according to claim 154 and wherein at least one of said at least two characteristics is selected from a set consisting of:
header information;
file content;
file name extension; and
file icon.

158. A system for detecting malicious content according to claim 157 and wherein said malicious content comprises malicious code.

159. A system for detecting malicious content according to claim 157 and wherein said malicious content comprises masqueraded content.

160. A system according to claim 126 and wherein:
said digital object information obtainer comprises a digital object information obtainer client subsystem;
said characteristic based categorizer comprises a characteristic based categorizer client subsystem;
said categories mismatch detector comprising a mismatch detector client subsystem; and
said digital object classifier comprising a mismatch detector client subsystem.

161. A system for detecting malicious content according to claim 160 and wherein said malicious content comprises malicious code.

162. A system for detecting malicious content according to claim 160 and wherein said malicious content comprises masqueraded content.

163. A system for detecting malicious content according to claim 160 and wherein at least one of said at least two characteristics is selected from a set consisting of:
header information;
file content;
file name extension; and
file icon.

164. A system for detecting malicious content according to claim 163 and wherein said malicious content comprises malicious code.

165. A system for detecting malicious content according to claim 164 and wherein said malicious content comprises masqueraded content.

166. A system for detecting malicious content according to claim 160 and wherein said digital object is selected from a set consisting of:
a file;
an e-mail attachment;
a web page; and
a storage medium.

167. A system for detecting malicious content according to claim 166 and wherein said malicious content comprises malicious code.

168. A system for detecting malicious content according to claim 166 and wherein said malicious content comprises masqueraded content.

169. A system for detecting malicious content according to claim 166 and wherein at least one of said at least two characteristics is selected from a set consisting of:
header information;
file content;
file name extension; and
file icon.

170. A system for detecting malicious content according to claim 169 and wherein said malicious content comprises malicious code.

171. A system for detecting malicious content according to claim 169 and wherein said malicious content comprises masqueraded content.

172. A system according to claim 126 and wherein:
said digital object information obtainer comprises a digital object information obtainer gateway subsystem;
said characteristic based categorizer comprises a characteristic based categorizer gateway subsystem;
said categories mismatch detector comprising a mismatch detector gateway subsystem; and
said digital object classifier comprising a mismatch detector gateway subsystem.

173. A system for detecting malicious content according to claim 172 and wherein said malicious content comprises malicious code.

174. A system for detecting malicious content according to claim 172 and wherein said malicious content comprises masqueraded content.

175. A system for detecting malicious content according to claim 172 and wherein at least one of said at least two characteristics is selected from a set consisting of:
header information;
file content;
file name extension; and
file icon.

176. A system for detecting malicious content according to claim 175 and wherein said malicious content comprises malicious code.

177. A system for detecting malicious content according to claim 175 and wherein said malicious content comprises masqueraded content.

178. A system for detecting malicious content according to claim 172 and wherein said digital object is selected from a set consisting of:
a file;
an e-mail attachment;
a web page; and
a storage medium.

179. A system for detecting malicious content according to claim 178 and wherein said malicious content comprises malicious code.

180. A system for detecting malicious content according to claim 178 and wherein said malicious content comprises masqueraded content.

181. A system for detecting malicious content according to claim 178 and wherein at least one of said at least two characteristics is selected from a set consisting of:
header information;
file content;
file name extension; and
file icon.

182. A system for detecting malicious content according to claim 181 and wherein said malicious content comprises malicious code.

183. A system for detecting malicious content according to claim 181 and wherein said malicious content comprises masqueraded content.

184. A system according to claim 126 and wherein:
said digital object information obtainer is selected from a set consisting of:
a digital object information server subsystem;
a digital object information client subsystem;
a digital object information gateway subsystem;
said characteristic based categorizer is selected from a set consisting of:
a characteristic based categorizer server subsystem;
a characteristic based categorizer client subsystem;
a characteristic based categorizer gateway subsystem;
said categories mismatch detector is selected from a set consisting of:
a categories mismatch detector server subsystem;
a categories mismatch detector client subsystem;
a categories mismatch detector gateway subsystem; and
said digital object classifier is selected from a set consisting of:
a digital object classifier server subsystem;
a digital object classifier client subsystem;
a digital object classifier gateway subsystem.

185. A system for detecting malicious content comprising:
a digital object examiner, examining at least two characteristics of a digital object, each of which characteristics may be selected by a creator of the digital object independently of selection of another characteristic;
a characteristics mismatch detector, analyzing said at least two characteristics to determine whether there exists a mismatch therebetween; and
a digital object classifier, operative upon determination of the existence of a mismatch, classifying said digital object as a digital object possibly containing malicious content.

186. A system for detecting malicious content according to claim 185 and wherein said malicious content comprises malicious code.

187. A system for detecting malicious content according to claim 185 and wherein said malicious content comprises masqueraded content.

188. A system for detecting malicious content according to claim 185 and wherein at least one of said at least two characteristics is selected from a set consisting of:
header information;
file content;
file name extension; and
file icon.

189. A system for detecting malicious content according to claim 188 and wherein said malicious content comprises malicious code.

190. A system for detecting malicious content according to claim 188 and wherein said malicious content comprises masqueraded content.

191. A system for detecting malicious content according to claim 185 and wherein said digital object is selected from a set consisting of:
a file;
an e-mail attachment;
a web page; and
a storage medium.

192. A system for detecting malicious content according to claim 191 and wherein said malicious content comprises malicious code.

193. A system for detecting malicious content according to claim 191 and wherein said malicious content comprises masqueraded content.

194. A system for detecting malicious content according to claim 191 and wherein at least one of said at least two characteristics is selected from a set consisting of:
header information;
file content;
file name extension; and
file icon.

195. A system for detecting malicious content according to claim 194 and wherein said malicious content comprises malicious code.

196. A system for detecting malicious content according to claim 194 and wherein said malicious content comprises masqueraded content.

197. A system for detecting malicious content according to claim 185 and wherein said digital object comprises a file.

198. A system for detecting malicious content according to claim 185 and wherein said digital object comprises an e-mail attachment.

199. A system for detecting malicious content according to claim 185 and wherein said digital object comprises a web page.

200. A system for detecting malicious content according to claim 185 and wherein said digital object comprises a storage medium.

201. A system for detecting malicious content according to claim 185 and wherein said at least two characteristics comprise:
header information; and
file content.

202. A system for detecting malicious content according to claim 185 and wherein said at least two characteristics comprise:
header information; and
file name extension.

203. A system for detecting malicious content according to claim 185 and wherein said at least two characteristics comprise:
header information; and
file icon.

204. A system for detecting malicious content according to claim 185 and wherein said at least two characteristics comprise:
file content; and
file icon.

205. A system for detecting malicious content according to claim 185 and wherein said at least two characteristics comprise:
file name extension; and
file icon.

206. A system for detecting malicious content according to claim 185 and wherein said at least two characteristics comprise:
file name extension; and
file content.

207. A system according to claim 185 and wherein:
said digital object examiner comprises a digital object examiner server subsystem;
said characteristics mismatch detector comprising a mismatch detector server subsystem; and
said digital object classifier comprising a mismatch detector server subsystem.

208. A system for detecting malicious content according to claim 207 and wherein said malicious content comprises malicious code.

209. A system for detecting malicious content according to claim 207 and wherein said malicious content comprises masqueraded content.

210. A system for detecting malicious content according to claim 207 and wherein at least one of said at least two characteristics is selected from a set consisting of:
header information;
file content;
file name extension; and
file icon.

211. A system for detecting malicious content according to claim 210 and wherein said malicious content comprises malicious code.

212. A system for detecting malicious content according to claim 210 and wherein said malicious content comprises masqueraded content.

213. A system for detecting malicious content according to claim 207 and wherein said digital object is selected from a set consisting of:
a file;
an e-mail attachment:
a web page; and
a storage medium.

214. A system for detecting malicious content according to claim 213 and wherein said malicious content comprises malicious code.

215. A system for detecting malicious content according to claim 213 and wherein said malicious content comprises masqueraded content.

216. A system for detecting malicious content according to claim 213 and wherein at least one of said at least two characteristics is selected from a set consisting of:
header information;
file content;
file name extension; and
file icon.

217. A system for detecting malicious content according to claim 216 and wherein said malicious content comprises malicious code.

218. A system for detecting malicious content according to claim 216 and wherein said malicious content comprises masqueraded content.

219. A system according to claim 185 and wherein:
said digital object examiner comprises a digital object examiner client subsystem;
said characteristics mismatch detector comprising a mismatch detector client subsystem; and
said digital object classifier comprising a mismatch detector client subsystem.

220. A system for detecting malicious content according to claim 219 and wherein said malicious content comprises malicious code.

221. A system for detecting malicious content according to claim 219 and wherein said malicious content comprises masqueraded content.

222. A system for detecting malicious content according to claim 219 and wherein at least one of said at least two characteristics is selected from a set consisting of:
header information;
file content;
file name extension; and
file icon.

223. A system for detecting malicious content according to claim 222 and wherein said malicious content comprises malicious code.

224. A system for detecting malicious content according to claim 223 and wherein said malicious content comprises masqueraded content.

225. A system for detecting malicious content according to claim 219 and wherein said digital object is selected from a set consisting of:
a file;
an e-mail attachment;
a web page; and
a storage medium.

226. A system for detecting malicious content according to claim 225 and wherein said malicious content comprises malicious code.

227. A system for detecting malicious content according to claim 225 and wherein said malicious content comprises masqueraded content.

228. A system for detecting malicious content according to claim 225 and wherein at least one of said at least two characteristics is selected from a set consisting of:
header information;
file content;
file name extension; and
file icon.

229. A system for detecting malicious content according to claim 228 and wherein said malicious content comprises malicious code.

230. A system for detecting malicious content according to claim 228 and wherein said malicious content comprises masqueraded content.

231. A system according to claim 185 and wherein:
said digital object examiner comprises a digital object examiner gateway subsystem;
said characteristics mismatch detector comprising a mismatch detector gateway subsystem; and
said digital object classifier comprising a mismatch detector gateway subsystem.

232. A system for detecting malicious content according to claim 231 and wherein said malicious content comprises malicious code.

233. A system for detecting malicious content according to claim 231 and wherein said malicious content comprises masqueraded content.

234. A system for detecting malicious content according to claim 231 and wherein at least one of said at least two characteristics is selected from a set consisting of:
header information;
file content;
file name extension; and
file icon.

235. A system for detecting malicious content according to claim 234 and wherein said malicious content comprises malicious code.

236. A system for detecting malicious content according to claim 234 and wherein said malicious content comprises masqueraded content.

237. A system for detecting malicious content according to claim 231 and wherein said digital object is selected from a set consisting of:
a file;
an e-mail attachment;
a web page; and
a storage medium.

238. A system for detecting malicious content according to claim 237 and wherein said malicious content comprises malicious code.

239. A system for detecting malicious content according to claim 237 and wherein said malicious content comprises masqueraded content.

240. A system for detecting malicious content according to claim 237 and wherein at least one of said at least two characteristics is selected from a set consisting of:
header information;
file content;
file name extension; and
file icon.

241. A system for detecting malicious content according to claim 240 and wherein said malicious content comprises malicious code.

242. A system for detecting malicious content according to claim 240 and wherein said malicious content comprises masqueraded content.

243. A system according to claim 185 and wherein:
said digital object examiner is selected from a set consisting of:
a digital object examiner server subsystem;
a digital object examiner client subsystem;
a digital object examiner gateway subsystem;
said digital characteristics mismatch detector is selected from a set consisting of:
a characteristics mismatch detector server subsystem;
a characteristics mismatch detector client subsystem;
a characteristics mismatch detector gateway subsystem; and
said digital object classifier is selected from a set consisting of:
a digital object classifier server subsystem;
a digital object classifier client subsystem;
a digital object classifier gateway subsystem.
